(19) United States
(12) Patent Application Publication
(10) Pub. No.: US 2026/0074835 A1
(43) Pub. Date: Mar. 12, 2026

(54) COMMUNICATION APPARATUS, INFORMATION PROCESSING APPARATUS, CONTROL METHOD, AND STORAGE MEDIUM

(71) Applicant: CANON KABUSHIKI KAISHA, Tokyo (JP)

(72) Inventor: EIGORO INA, Kanagawa (JP)

(21) Appl. No.: 19/388,395

(22) Filed: Nov. 13, 2025

Related U.S. Application Data
(63) Continuation of application No. PCT/JP2024/015518, filed on Apr. 19, 2024.

(30) Foreign Application Priority Data
May 16, 2023 (JP) 2023-081139

(51) Int. Cl. H04L 1/1607

(52) U.S. Cl. CPC H04L 1/1657

(57) ABSTRACT

A communication apparatus that executes communication compliant with IEEE 802.11, the communication apparatus includes a first receiving unit configured to receive at least part of a first communication frame including information indicating that Special Reuse (SR) is allowed, the first communication frame having been transmitted by a first different communication apparatus, a detecting unit configured to detect a second communication frame that interferes with reception of the first communication frame, the second communication frame having been transmitted by a second different communication apparatus, and a notifying unit configured to notify the first different communication apparatus of an error in reception of the first communication frame, based on a signal strength of the signal received by the first receiving unit and a signal strength of the second communication frame detected by the detecting unit.

### CROSS-REFERENCE TO RELATED APPLICATIONS

This application is a Continuation of International Patent Application No. PCT/JP2024/015518, filed Apr. 19, 2024, which claims the benefit of Japanese Patent Application No. 2023-081139, filed May 16, 2023, both of which are hereby incorporated by reference herein in their entirety.

### BACKGROUND

### Field of the Technology

The present disclosure relates to an apparatus that executes communication control.

### Description of the Related Art

In recent years, various kinds of IEEE 802.11 standards aimed at efficient use of wireless media in environments where a large number of wireless communication apparatuses exist have been studied. In these studies, Spatial Reuse (SR) processing has been studied as a technique for enabling a plurality of basic service sets (BSSs) to efficiently use a wireless medium. The SR processing is a communication technique for efficiently using a wireless medium in an Overlapping Basic Service Set (OBSS) environment where a plurality of BSSs is positioned to overlap each other. As identification information for identifying an individual BSS, a method using information called BSS Color has been under consideration. In this method, a BSS Color is embedded in a physical layer header and transmitted. Japanese Patent Laid-Open No. 2017-225091 describes a technique for determining whether a signal is an uplink signal or a downlink signal of an OBSS by using a BSS Color and performing transmission control.

In conventional SR processing, when a communication packet subject to SR processing receives an undesired signal having a strength higher than expected from another apparatus in one OBSS, an apparatus cannot successfully receive the communication packet, and an error occurs. However, because the another apparatus cannot appropriately determine the occurrence of the error or the cause of the error, stable communication cannot be performed.

### SUMMARY

In view of the above-described issue, the present disclosure is directed to providing a method that enables execution of suitable communication even in a case where an error has occurred during execution of SR processing.

A communication apparatus that executes communication compliant with IEEE 802.11, the communication apparatus includes at least one memory that stores a set of instructions, and at least one processor that executes the instructions, the instructions, when executed, causing the communication apparatus to perform operations including receiving, as first receiving, at least part of a first communication frame including information indicating that Special Reuse (SR) is allowed, the first communication frame having been transmitted by a first different communication apparatus, detecting a second communication frame that interferes with reception of the first communication frame, the second communication frame having been transmitted by a second different communication apparatus, and notifying the first different communication apparatus of an error in reception of the first communication frame, based on a signal strength of the signal received by the first receiving and a signal strength of the second communication frame detected by the detecting.

Features of the present disclosure will become apparent from the following description of embodiments with reference to the attached drawings.

### BRIEF DESCRIPTION OF THE DRAWINGS

FIG. 1 illustrates an example of an overall configuration of a network.

FIG. 2 illustrates an example of a hardware configuration.

FIG. 3 is a block diagram illustrating an example of a functional configuration.

FIG. 4 is a time sequence diagram.

FIG. 5 illustrates an operation flow procedure of a communication apparatus (access point (AP)).

FIG. 6A illustrates an example of a configuration of an SR_Parameter_set element.

FIG. 6B illustrates an example of a configuration of an SR_Control field.

FIG. 6C illustrates an example of a configuration of Ultra High Reliability Trigger-Based Physical Layer Protocol Data Unit (UHR TB PPDU).

FIG. 6D illustrates an example of a configuration of Universal Signal 2 (U-SIG 2).

### DESCRIPTION OF THE EMBODIMENTS

Hereinafter, embodiments will be described in detail with reference to the accompanying drawings. Configurations described in the following embodiments are merely examples, and the present disclosure is not limited to the described configurations.

### (Configuration of Wireless Communication System)

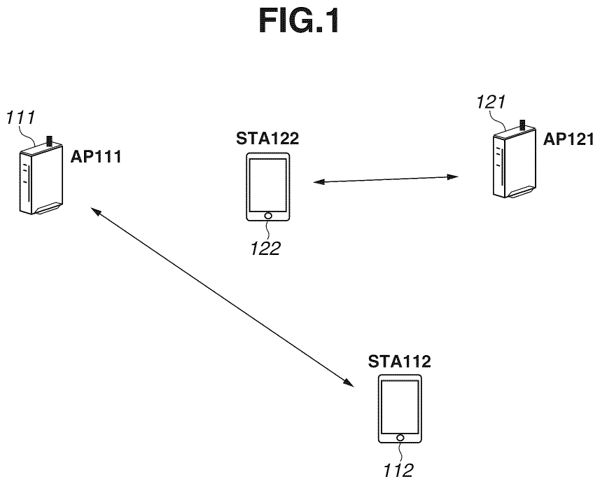

FIG. 1 illustrates a system configuration according to the present embodiment. This wireless communication system includes access point apparatuses (APs) and station apparatuses (STAs).

FIG. 1 illustrates a configuration of a network constructed by a communication apparatus 111 (AP 111) and a network constructed by a communication apparatus 121 (AP 121) adjacent to the network constructed by the AP 111. The AP 111 has established a wireless communication connection with a communication apparatus 112 (STA 112). That is, the AP 111 and the STA 112 have established a connection with each other by performing a process, such as Association Request/Response, 4-way handshake, or the like. In addition, the AP 121 has established a wireless communication connection with a communication apparatus 122 (STA 122).

Each of the AP 111, the STA 112, the AP 121, and the STA 122 is configured to enable communication using wireless frames that are compliant with the Institute of Electrical and Electronics Engineers (IEEE) 802.11bn standard, which is a successor to the IEEE 802.11be standard and is aims to achieve the maximum transmission rate of 46.08 Gigabits per second (Gbps).

This successor to the IEEE 802.11be has key features, such as support of high-reliability communication and low-latency communication, AP cooperation, and improvement of throughput in a congested state. In view of the above key features, in the present embodiment, the successor of the IEEE 802.11be standard will be referred to as IEEE 802.11bn. Further, a wireless frame that communicates by using the IEEE 802.11bn standard will be referred to as Ultra High Reliability Physical Layer Convergence Protocol (PLCP) Protocol Data Unit (UHR PPDU).

The names “IEEE 802.11bn” and “UHR” are used for convenience in view of the goals to be achieved by the successor and the key features of this standard, and may be replaced with different names when the standard is finalized. Note that the present specification and the appended claims are basically applicable to all successors to the IEEE 802.11be standard that can be supported.

Each communication apparatus can perform communication in the 2.4 Gigahertz (GHz) frequency band, 3.6 GHz frequency band, 5 GHz frequency band, and 6 GHz frequency band, and also in the 45 GHz frequency band and 60 GHz frequency band, which are called millimeter waves. The frequency bands to be used by each communication apparatus are not limited to the above frequency bands, and a different frequency band, such as a Sub1 GHz frequency band, may be used. In addition, each communication apparatus can perform communication by using bandwidths of 20 MHz, 40 Megahertz (MHz), 80 MHz, 160 MHz, 320 MHz, 540 MHz, 640 MHz, 1080 MHz, and 2160 MHz. The bandwidths to be used by each communication apparatus are not limited to the above bandwidths, and a different bandwidth, such as 240 MHz and 4 MHz, may be used.

The AP 111, the STA 112, the AP 121, and the STA 122 can perform multi-user (MU) communication in which signals of a plurality of users are multiplexed by executing Orthogonal Frequency Division Multiple Access (OFDMA) communication compliant with the IEEE 802.11 standard. In the OFDMA communication, a divided part of the frequency band (a resource unit (RU)) is individually allocated to each STA without overlap, and the carrier waves of the STAs are orthogonal to each other. As a result, the APs can communicate with a plurality of STAs in parallel within their respectively defined bandwidths.

As described above, each communication apparatus is compliant with the IEEE 802.11bn standard. In addition, each communication apparatus may support legacy standards, which are standards preceding the IEEE 802.11bn standard, or standards succeeding the IEEE 802.11bn standard. Specifically, each communication apparatus may support at least one of the IEEE 802.11a/b/g/n/ac/ax/be standards. Further, each communication apparatus may support not only the IEEE 802.11 series of standards, but also other communication standards, such as Bluetooth®, Near Field Communication (NFC), Ultra Wide Band (UWB), ZigBee, and Multi Band OFDM Alliance (MBOA). Examples of the UWB include Wireless USB, Wireless IEEE 1394, and WiNET. Alternatively, each communication apparatus may support wired communication standards, such as a wired local area network (LAN). Specific examples of the AP 111 and the AP 121 include a wireless LAN router and a personal computer (PC). However, the examples of the AP 111 and the AP 121 are not limited thereto. The AP 111 and the AP 121 may be information processing devices, such as wireless chips, capable of executing wireless communication compliant with the IEEE 802.11bn standard. Specific examples of the STA 112 and the STA 122 include a camera, a tablet, a smartphone, a PC, a mobile phone, a video camera, and a headset. However, the examples of the STA 112 and the STA 122 are not limited thereto. The STA 112 and the STA 122 may be information processing devices, such as wireless chips, capable of executing wireless communication compliant with the IEEE 802.11bn standard. Although the wireless networks in FIG. 1 include two APs and two STAs, the number and arrangement of APs and STAs are not limited to this example.

Each communication apparatus uses Spatial Reuse (SR) that is compliant with, for example, the IEEE 802.11 standards, and can transmit a communication frame even when another network is operating on the same frequency band.

In communication using the SR processing (spatial reuse communication), when one communication apparatus receives a signal transmitted by another communication apparatus, the one communication apparatus determines whether this signal is directed to the Basic Service Set (BSS) to which the one communication apparatus belongs. If the signal is directed to a BSS other than the BSS to which the one communication apparatus belongs, the one communication apparatus determines whether a transmission signal of the one communication apparatus affects the another BSS. If the one communication apparatus determines that the transmission signal of the one communication apparatus does not affect the another BSS, the one communication apparatus transmits a signal. In this way, efficient use of the wireless medium can be achieved. As specific operations, there are two methods, which are an Overlapping BSS Packet Detect (OBSS_PD)-based SR method and a Spatial Reuse Parameters (SRP)-based SR method.

The OBSS PD-based SR method is a method in which, when one communication apparatus determines that a received signal belongs to another BSS, the one communication apparatus dynamically changes a carrier sense level, at which a signal of the one communication apparatus can be transmitted, by controlling a carrier sense threshold and the transmission power, and transmits a signal. The SRP-based method is a method in which a parameter value relating to a reception interference level, which is allowable in a BSS to which an Access Point (AP) belongs, is provided by using a trigger frame, and a terminal belonging to another BSS determines the transmission level based on the parameter value and transmits a signal.

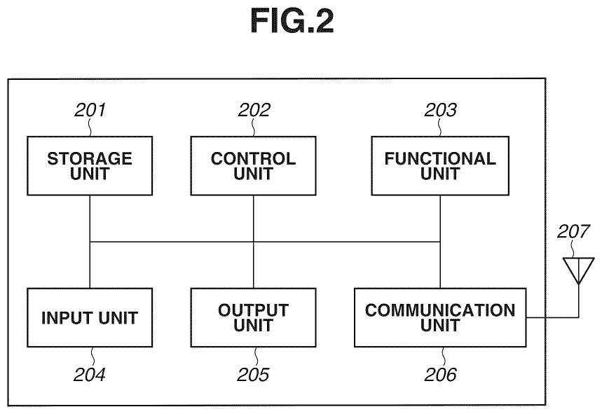

FIG. 2 illustrates an example of a hardware configuration of the AP 111 according to the present embodiment. The AP 111 includes a storage unit 201, a control unit 202, a functional unit 203, an input unit 204, an output unit 205, a communication unit 206, and an antenna 207. The AP 111 may include a plurality of antennas.

The storage unit 201 includes one or more memories, such as a Read-Only Memory (ROM) or a Random Access Memory (RAM), and stores computer programs for performing various kinds of operations, which will be described below, and various kinds of information, such as communication parameters for wireless communication. Not only a ROM or a RAM, but also a storage medium, such as a flexible disk, a hard disk, an optical disk, a magneto-optical disk, a Compact Disc (CD)-ROM, a CD-Recordable (CD-R), a magnetic tape, a nonvolatile memory card, or a Digital Versatile Disc (DVD) may be used as the storage unit 201. The storage unit 201 may include a plurality of memories or the like.

The control unit 202 includes, for example, one or more processors, such as a Central Processing Unit (CPU) or a Micro Processing Unit (MPU), and controls the entire AP 111 by executing a computer program stored in the storage unit 201. The control unit 202 may control the entire AP 111 by executing a computer program stored in the storage unit 201 in cooperation with an operating system (OS). In addition, the control unit 202 generates data and signals (wireless frames) to be transmitted in communication with another communication apparatus. The control unit 202 may include a plurality of processors, such as a multi-core processor, and the plurality of processors may control entire operation of the AP 111. The control unit 202 controls the functional unit 203 to execute predetermined processing, such as wireless communication, imaging, printing, and projection.

The functional unit 203 is hardware with which the AP 111 executes predetermined processing. When the functional unit 203 is a printer, the functional unit 203 prints image data acquired via the communication unit 206. When the functional unit 203 is a scanner, the functional unit 203 transmits image data generated by its scanning operation to an external apparatus via the communication unit 206. When the functional unit 203 is a camera, the functional unit 203 transmits image data captured by its image capturing operation to an external apparatus via the communication unit 206.

The input unit 204 includes a touch panel, a keyboard, buttons, etc., and receives various kinds of operations from a user. The output unit 205 performs various kinds of outputs to the user via a monitor screen or a speaker. The outputs by the output unit 205 may include displaying on a monitor screen, audio output via a speaker, vibration output, and the like. Alternatively, both the input unit 204 and the output unit 205 may be implemented by a single module, such as a touch panel. The input unit 204 and the output unit 205 may be integrated with the AP 111 or may be provided separately from the AP 111.

The communication unit 206 controls wireless communication that is compliant with the IEEE 802.11 series of standards. The communication unit 206 may control wireless communication that is compliant with the other IEEE 802.11 series of standards, in addition to the IEEE 802.11ax standard, and wired communication, such as a wired LAN. The communication unit 206 controls the antenna 207 to transmit and receive wireless communication signals generated by the control unit 202.

In a case where the STA 112 supports the NFC standard, the Bluetooth® standard, or the like, in addition to the IEEE 802.11ax standard, the communication unit 206 may control wireless communication that is compliant with these communication standards. In addition, when the AP 111 can execute wireless communication that is compliant with a plurality of communication standards, the AP 111 may include communication units and antennas for their respective communication standards. The AP 111 communicates data, such as image data, document data, and video data, to and from the STA 112 via the communication unit 206. The antenna 207 may be configured separately from the communication unit 206 or may be configured together with the communication unit 206 as a single module.

The antenna 207 is an antenna capable of communication in any of the 2.4 GHz frequency band, the 5 GHz frequency band, and the 6 GHz frequency band. In the present embodiment, the AP 111 includes one antenna, but may include a plurality of antennas. Alternatively, different antennas may be provided for different frequency bands. In addition, in a case where the AP 111 includes a plurality of antennas, the AP 111 may include a communication unit 206 corresponding to each of the antennas.

While the STA 112 has a hardware configuration similar to that of the AP 111, but is not limited thereto. For example, the configurations of the input unit 204 and the output unit 205 of each STA may be different from those of the AP 111. In the present embodiment, the AP 121 and the STA 122 have a hardware configuration similar to that of the AP 111.

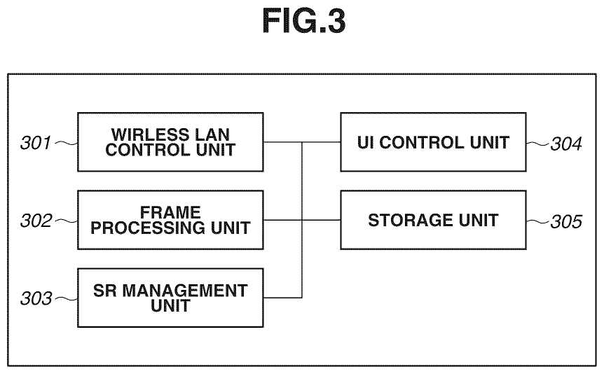

FIG. 3 is a block diagram illustrating a functional configuration of the AP 111 according to the present embodiment. For example, this functional configuration is realized by one or more processors executing programs stored in one or more memories. The AP 121, the STA 112, and the STA 122 each have a similar configuration. In the present embodiment, the AP 111 includes a wireless LAN control unit 301. The number of wireless LAN control units is not limited to one, and may be two or more. The AP 111 further includes a frame processing unit 302, an SR management unit 303, a user interface (UI) control unit 304, a storage unit 305, and a wireless antenna (not illustrated).

The wireless LAN control unit 301 includes an antenna and a circuit for transmitting and receiving a wireless signal to and from another wireless LAN device, and programs for controlling the antenna and the circuit. The wireless LAN control unit 301 executes wireless LAN communication control based on frames generated by the frame processing unit 302 in accordance with the IEEE 802.11 series of standards.

The frame processing unit 302 processes wireless control frames transmitted and received by the wireless LAN control unit 301. The content of the wireless control generated and analyzed by the frame processing unit 302 may be restricted by settings stored in the storage unit 305. The content of the wireless control may be changed based on user settings via the UI control unit 304. The information about a generated frame is supplied to the wireless LAN control unit 301 and transmitted to a communication counterpart. The information about the frame received by the wireless LAN control unit 301 is transmitted to the frame processing unit 302 and analyzed.

When the AP 111 transmits a communication frame by using SR, the SR management unit 303 determines whether the communication frame can be transmitted, based on the parameters that have been acquired via the frame processing unit 302. In a case where the communication frame can be transmitted, the SR management unit 303 determines the signal strength, the modulation degree, and the packet length of a communication frame to be transmitted, and generates a transmission packet via the frame processing unit 302.

The UI control unit 304 includes hardware relating to a user interface, such as a touch panel or buttons, for receiving an operation performed on the AP 111 by a user (not illustrated) of the AP 111, and programs for controlling the hardware. The UI control unit 304 also has a function of presenting information, for example, by displaying an image or outputting audio to the user.

The storage unit 305 may be configured with a storage device that includes a ROM, a RAM, and the like for storing programs and data for operating the AP 111.

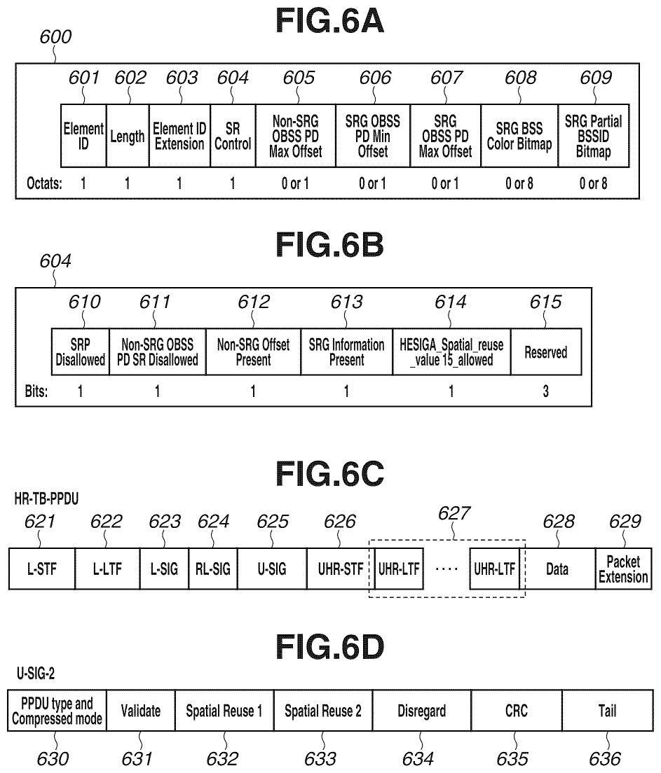

FIGS. 6A and 6B illustrate an example of a frame format in a MAC layer, and illustrate an example of a format of an information element (IE) relating to the function of the SR processing. The information relating to the SR processing is included in a MAC frame, and transmitted and received. In this way, a control operation relating to the SR processing can be executed.

FIGS. 6A and 6B illustrate the format of an SR_Parameter_set element 600. By adding the SR_Parameter_set element 600 to a predetermined MAC frame, a control operation relating to the SR processing can be performed between communication apparatuses.

The SR_Parameter_set element 600 includes a plurality of fields. Element_ID 601, Length 602, and Element_ID_Extention 603 are fields including basic information for identifying data of the information element. An SR_Control field 604 enables a more detailed control operation relating to the SR processing by using parameters of subfields, which will be described below. A Non-SRG (SR_Group)_OBSS_PD_Max_Offset field 605 is used for generating a value of a Non-SRG_OBSS_PD_Max parameter. An SRG_OBSS_PD_Min_Offset field 606 is used for generating the value of an SRG_OBSS_PD_Min parameter. An SRG_OBSS_PD_Max_Offset field 607 is used for generating the value of an SRG_OBSS_PD_Max parameter.

An OBSS_PD-based SR method, which is one example of the above-described SR processing described above, will be described in more detail. The OBSS_PD-based SR method is further classified into two processing types. One is processing using a Non-SRG_OBSS_PD level. This processing method is used when a non-SRG packet is detected. The other is processing using an SRG_OBSS_PD level. This processing method is used when an SRG packet is detected. The above-described fields 605, 606, and 607 are parameters relating to these two processing methods, and are used for calculating the signal strength value to be used for packet detection.

An SRG_BSS_Color_Bitmap field 608 is a field indicating, in the form of a bitmap, a value of a BSS color that is used in the SRG to which an apparatus transmitting a signal belongs as a member. An SRG_Partial_BSSID_Bitmap field 609 is a field indicating, in the form of a bitmap, a partial value of a BSSID that is used in the SRG to which the apparatus transmitting a signal belongs as a member.

The SR_Control field 604 includes a plurality of subfields. An SRP Disallowed subfield 610 indicates whether the SR processing by the SRP-based SR method is invalid in the wireless network constructed by the AP. A Non-SRG_OBSS_PD_SR_Disallowed field 611 indicates whether the SR processing using the Non-SRG_OBSS_PD level is invalid in the wireless network constructed by the AP. A Non-SRG_Offset_Present subfield 612 indicates whether the Non-SRG_OBSS_PD_Max Offset field 605 is included in the frame. An SRG_Information_Present subfield 613 indicates whether the above-described fields 606, 607, 608, and 609 are included in the SR_Parameter_set element. The information relating to the SRG can be shared by using these fields. An HESIGA_Spatial_reuse_value15_allowed field 614 indicates whether the value of SRP_AND_NON_SRG_OBSS_PD_PROHIBITED can be set to SPATIAL_REUSE, which is a parameter in TXVECTOR passing between MAC and PHY. By using this parameter, the SR processing by the SRP method and the OBSS_PD method using the Non-SRG_OBSS_PD level can be prohibited during the transmission of a target PPDU.

Next, an example of a method that is performed when the SR processing is not used will be described. When the SR processing is not used in the constructed wireless network, the SR_Parameter_set element 600 described above is used. The value of the SRG_Information_Present subfield 613 included in the SR_Parameter_set element 600 is set to be invalid (0). Accordingly, information relating to SRG will not be included in the SR_Parameter_set element. Thus, there will be no SRG in the wireless network, and the SR processing using the SRG_OBSS_PD level of the OBSS_PD-based SR method will not be performed. In addition, the value of the SRP Disallowed subfield 610 is set to be valid (1). Accordingly, the SR processing by the SRP-based SR method will be disallowed in the wireless network constructed by GO. Further, the value of the Non-SRG_OBSS_PD_SR_Disallowed field 611 is set to be valid (1). Accordingly, the SR processing using the Non-SRG_OBSS_PD level of the OBSS_PD-based SR method will be disallowed in the wireless network.

The SR_Parameter_set element in which these values are set is added to a wireless frame (such as a beacon or Probe_Response) as the information element, and the communication apparatus transmits the wireless frame to a Client. In this way, the use of the SR processing in the wireless network can be restricted.

After it is determined that the SR processing is not to be used, the input unit 204 or the output unit 205 may notify the user that the SR processing is not to be used in the wireless network by displaying the information. Alternatively, the input unit 204 may allow the user to select whether to use the SR processing in the wireless network.

The method for disallowing the use of the SR processing in the wireless network is not limited the above example. The use of the SR processing may be disallowed by controlling other parameters. For example, the use of the SR processing may be controlled by using parameters included in an HE_Capability element that is added to the MAC frame. For example, an SRP-based_SR_Support subfield in a PHY_Capabilities_Information field may be used. This subfield indicates whether the SR processing by the SRP method is supported. Further, the HE_Capability element indicating that the SR processing is not supported may be added to a predetermined wireless frame and transmitted.

Alternatively, the use of the SR processing may be disallowed by controlling a parameter in header information in the PHY frame. U-SIG or the like in the PHY frame, which will be described below, may be used. A wireless frame including a physical header in which a parameter value of SRP_DISALLOW or SRP_AND_NON_SRG_OBSS_PD_PROHIBITED is set as a value of this field may be transmitted.

A method that is performed when the SR processing is used will be described. The value of the SRG_Information_Present subfield 613 included in the SR_Parameter_set element 600 is set to be valid (1). In addition, information is entered into the fields 606, 607, 608, and 609 relating to SRG, and these fields are added to the SR_Parameter_set element. Consequently, the SRG information is enabled in the wireless network constructed by the GO, and the SR processing using the SRG_OBSS_PD level of the OBSS_PD method will be allowed in the wireless network.

In addition, similarly, the value of the SRP Disallowed subfield 610 is set to be invalid (0). Consequently, the SR processing by the SRP-based SR method will be allowed in the wireless network constructed by the AP. Further, the value of the Non-SRG_OBSS_PD_SR Disallowed field 611 is set to be invalid (0). Consequently, the SR processing using the Non-SRG_OBSS_PD level of the OBSS_PD-based SR method will be allowed in the wireless network constructed by the AP. The SR_Parameter_set element in which these values are set is added to a wireless frame (such as a beacon or Probe_Response) as the information element, and the AP transmits the wireless frame to the Client. In this way, the use of the SR processing on the Client side can be allowed.

The above-described method for allowing the use of the SR processing is not limited to this example. The parameters of a different information element that can be added to the MAC frame may be controlled and transmitted. Further, a value that enables the use of the SR processing may be set in a Spatial_Reuse field included in a field in the PHY frame header or the like, and the wireless frame may be transmitted. Alternatively, another wireless frame may be extended and transmitted to notify the user that the use of the SR processing is allowed.

FIGS. 6C and 6D illustrate an example of a configuration of a PHY frame of a Physical Layer (PHY) Protocol Data Unit (PPDU) with which the communication apparatus communicates according to the present embodiment. FIGS. 6C and 6D illustrate an example of a configuration of the PHY frame of a UHR Trigger-Based (TB) PPDU.

The present frame includes a Legacy Short Training Field (L-STF) 621, a Legacy Long Training Field (L-LTF) 622, an Legacy Signal (L-SIG) 623, a Repeated Legacy Signal (RL-SIG) 624, a Universal Signal (U-SIG) 625, a Ultra High Reliability Short Training Field (UHR-STF) 626, and Ultra High Reliability Long Training Fields (UHR-LTFs) 627 in this order from the head. In addition, the UHR-LTFs 627 are followed by a Data field 628 and a Packet Extension 629. The order of the fields of the PPDU is not limited to this example.

The L-STF 621, the L-LTF 622, and the L-SIG 623 are each backward compatible with the IEEE 802.11a/b/g/n/ac/ax/be standards, which are legacy standards developed before the IEEE 802.11bn standard. That is, the L-STF 621, the L-LTF 622, and the L-SIG 623 are legacy fields that can be decoded by a communication apparatus that supports the IEEE 802.11 series of standards including the IEEE 802.11be standard and IEEE 802.11 standards before the IEEE 802.11be standard.

The L-STF 621 is used for detection of a wireless packet signal, Automatic Gain Control (AGC), timing detection, etc. The L-LTF 622 is used for high-precision frequency and time synchronization, acquisition of Channel State Information (CSI), and the like. The L-SIG 623 is used for transmitting control information including information about a data transmission rate and a packet length. The RL-SIG 624 is used to identify that the standard is one subsequent to the IEEE 802.11ac standard. The RL-SIG 624 may be omitted.

The UHR-STF 626 and the UHR-LTFs 627 are fields that can be decoded by a communication apparatus that supports the IEEE 802.11UHR standard.

The L-STF 621, the L-LTF 622, the L-SIG 623, the RL-SIG 624, the U-SIG 625, the UHR-STF 626, and the UHR-LTFs 627 are collectively referred to as PHY preambles.

The U-SIG 625 is divided into two fields, which are a U-SIG-1 field and a U-SIG-2 field.

The U-SIG-1 field includes subfields illustrated in Table 1.

TABLE 1

| | | Number | |
|---|---|---|---|
| Bit Position | Subfield | of Bits | Description |
| B0-B2 | PHY Version | 3 | Identify PHY Version |
| | Identifier | | |
| B3-B5 | Bandwidth | 3 | Indicate Bandwidth to be |
| | | | Used for Communication |
| B6 | UL/DL | 1 | Indicate UL/DL |
| B7-B12 | BSS Color | 6 | BSS Identifier |
| B13-B19 | TXOP | 7 | Indicate NAV Settings And |
| | | | Information about TXOP |
| | | | Protection Period |
| B20-B25 | Disregard | 6 | Reserved |

The U-SIG-2 field includes subfields illustrated in Table 2.

TABLE 2

| | | Number | |
|---|---|---|---|
| Bit Position | Subfield | of Bits | Description |
| B0-B1 | PPDU Type And | 2 | “0 (Zero)” is set for |
| | Compressed Mode | | TB PPDU |
| B2 | Validate | 1 | Reserved |
| B3-B6 | Spatial Reuse 1 | 4 | Indicate Information |
| | | | about Spatial Reuse |
| B7-B10 | Spatial Reuse 2 | 4 | Indicate Information |
| | | | about Spatial Reuse |
| B11-B15 | Disregard | 5 | Reserved |
| B16-B19 | CRC | 4 | CRC |
| B20-B25 | Tail | 6 | Indicate End of Subfield |

The communication apparatus indicates information relating to Spatial Reuse by using the subfields “Spatial Reuse 1” and “Spatial Reuse 2”.

The meanings of values in the subfields “Spatial Reuse 1” and “Spatial Reuse 2” will be described. The value “0” in each subfield indicates PSR_DISALLOW, which means prohibition of PSR-based Spatial Reuse. The value “15” in each subfield indicates PSR_AND_NON_SRG_OBSS_PD_PROHIBITED, which means prohibition of PSR-based and OBSS PD-based Spatial Reuse. When the value of each subfield is 1 to 14, the apparatus that executes the PSR-based Spatial Reuse determines the upper limit of the transmission power based on the value of the PSR indicated in the subfield.

### First Embodiment

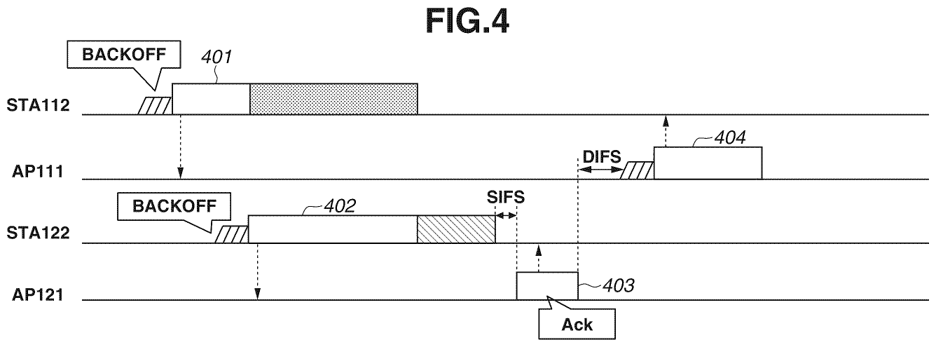

FIG. 4 is a time sequence diagram illustrating a case where the STA 112 transmits a communication frame that allows SR to the AP 111 according to the present embodiment. The procedure of the operation according to the present embodiment will be described with reference to FIG. 4.

In the present embodiment, the APs and the STAs are in a positional relationship as illustrated in FIG. 1. A communication frame 401 transmitted from the STA 112 to the AP 111 has a PHY header including information indicating that the STA 112 accepts the OBSS PD-based SR, that is, information indicating that the STA 112 allows the OBSS PD-based SR. While, in the present embodiment, the information indicating that the OBSS PD-based SR is allowed is included in the PHY frame, the information may be included in a MAC frame. The STA 122 included in the network constructed by the AP 121 detects that the OBSS PD-based SR is allowed, from the PHY header of the communication frame 401 transmitted by the STA 112, and transmits a communication frame 402 to the AP 121 by using SR in accordance with the IEEE 802.11 standard.

The AP 111 is originally intended to receive the communication frame 401 transmitted by the STA 112. However, the STA 122 that belongs to the OBSS is located closer to the AP 111 than the STA 112. Therefore, the AP 111 cannot sufficiently secure the ratio of the strength of the signal from the STA 112, which is the desired signal, to the strength of the signal from the STA 122, which is the undesired signal. That is, since a received Signal-to-Interference plus Noise power Ratio (SINR), which is a ratio of the received signal power to the interference-and-noise power in consideration of OBSS interference, is insufficient at the AP 111, the received signal cannot be correctly demodulated. The present embodiment describes a case in which the communication frame 402 interferes with a shaded portion of the communication frame 401, and the AP 111 has failed to correctly receive and demodulate the communication frame 401.

Before the STA 122 starts transmission of the communication frame 402, the STA 122 reads the PHY header included in the communication frame 401 transmitted by the STA 112, and ensures backoff time to avoid contention with other terminals. Therefore, the AP 111 has already received at least the PHY header portion of the communication frame 401 transmitted by the STA 112, and thus, the AP 111 has already detected information, such as the signal strength and the frame length of the communication frame 401 transmitted by the STA 112.

In a case where the end time of the communication frame 402 transmitted by the STA 122 is later than that of the communication frame 401 transmitted by the STA 112, the signal strength of the communication frame 402 transmitted by the STA 122 can be detected at the AP 111. In addition, in a case where the signal strength of the communication frame 402 transmitted by the STA 122 is stronger than the signal strength of the communication frame 401 transmitted by the STA 112 at the AP 111, the signal strength of the communication frame 402 transmitted by the STA 122 can be detected at the AP 111.

When the communication frame 402 transmitted by the STA 122 by using SR is correctly demodulated in the AP 121, which is the destination of the communication frame 402, the AP 121 transmits an acknowledgement (Ack) 403 to the STA 122. Since the Ack 403 includes the destination address, if the AP 111 can monitor this destination address, the AP 111 can detect the address of the apparatus that has transmitted the signal that has interfered with the communication frame 401 transmitted by the STA 112 immediately before, that is, the AP 111 can detect the identification information about the STA 122.

By the processing up to this point, although the AP 111 has failed to properly receive the communication frame 401 from the STA 112 as a result of allowing SR, the AP 111 has obtained three pieces of information. The first information is the signal strength of the signal transmitted by the STA 112, the second information is the signal strength of the signal transmitted by the STA 122, and the third information is the address of the STA 122. While the address is a MAC address in the present embodiment, any other information may be obtained as long as the information can identify the apparatus. On the other hand, the STA 112, which has transmitted the communication frame 401 to the AP 111, has not acquired these pieces of information. Without the above-described information, if the STA 112 transmits another communication frame that allows SR under the same conditions again, the AP 111 is highly likely to fail to correctly receive the communication frame again due to the same cause. Therefore, when the AP 111 cannot receive a communication frame from the STA 112 as a result of allowing SR, the AP 111 notifies the STA 112 of the above three pieces of information (the signal strength of the signal transmitted by the STA 112, the signal strength of the signal transmitted by the STA 122, and the address of the STA 122) by using an SR Fail Report frame 404. While, in the present embodiment, the AP 111 notifies the three pieces of information, the AP 111 may notify at least one piece of information, or three or more pieces of information. The STA 112, which has acquired the above three pieces of information, performs, for example, the following measures based on the information received as the SR Fail Report when retransmitting the communication frame that the AP 111 has failed to receive:
1. Change (lower) the degree of modulation (Modulation and Coding Scheme (MCS)) of the communication frame in such a manner that the demodulation can be performed by the AP 111 even when the SINR is low,
2. Increase the signal strength per frequency in such a manner that the SINR is increased, and
3. Determine that SR is not to be used, and change the PHY header portion to prohibit SR, that is, stop transmitting a communication frame indicating that SR is allowed, and transmit a communication frame indicating that SR is prohibited.

When the signal strength of the communication frame 402 from the STA 122 is equal to or greater than a certain level at the AP 111, even when the STA 112 transmits a communication frame that allows SR, the AP 111 is highly likely to fail to correctly demodulate the communication frame using SR since a strong signal is input from the STA 122 to the AP 111. Thus, it is possible to decide not to use SR. Determination of whether the transmission source apparatus that transmits the undesired signal is the STA 122 can be performed by reading the transmission source information in the MAC header portion. In addition, the AP 111 may determine not to use SR in a case where it can be estimated that the AP 111 will be affected to an extent equivalent to that when the transmission source is the STA 122, from information that can narrow down the transmission source with some accuracy, such as the BSS Color in the PHY header portion, and from the signal strength of its communication frame.

The SR Fail Report frame 404 does not need to be issued every time the AP 111 fails to receive a communication frame that allows SR. As one reference point, in a case where a reception frame error rate (FER), which is the rate of reception frame error caused by SR, exceeds a predetermined ratio, for example, 10%, the SR Fail Report is issued. In a case where the FER is less than 10%, the reception frame error is processed as a usual reception error without issuing the SR Fail Report, whereby the communication capacity can be maintained.

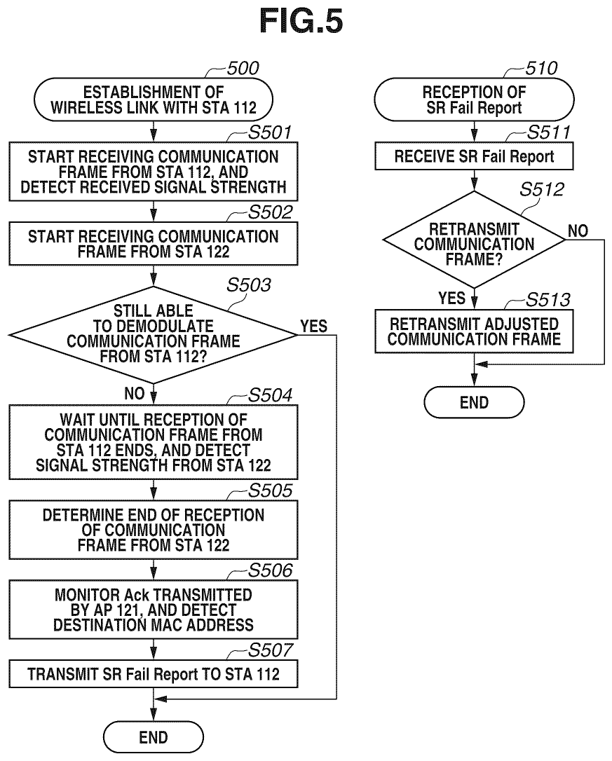

FIG. 5 is a flowchart 500 illustrating a procedure of issuing an SR Fail Report according to the present embodiment. The SR Fail Report is issued when the AP 111 has failed to properly receive a communication frame that allows SR, from the STA 112. Steps S501 to S507 are performed by, for example, the control unit 202 of the AP 111 executing a program stored in the storage unit 201.

First, a wireless communication connection is established in such a manner that the AP 111 and the STA 112 can perform wireless communication. Next, in step S501, the AP 111 starts receiving a communication frame that allows SR from the STA 112. Since the communication frame that allows SR includes information that SR is allowed in its PHY header portion, the AP 111 has properly received the PHY header portion of the communication frame. In this step, the AP 111 detects the signal strength of the communication frame transmitted by the STA 112. In particular, the AP 111 detects the received signal strength of the communication frame transmitted by the STA 112 at the AP 111.

In step S502, the STA 122 starts transmitting a communication frame by using SR, and the AP 111 receives the communication frame from the STA 122. At this point, the AP 111 receives both the communication frame from the STA 112 and the communication frame from the STA 122.

Subsequently, in step S503, the AP 111 determines whether the AP 111 can still demodulate the communication frame from the STA 112. In a case where the AP 111 is able to demodulate the communication frame from the STA 112 (YES in step S503), the AP 111 continues the usual reception processing and ends the process.

In a case where the AP 111 has become unable to demodulate the communication frame from the STA 112 (NO in step S503), the processing proceeds to step S504. In step S504, the AP 111 waits until the reception of the communication frame from the STA 112 ends based on the frame length obtained from the header portion of the communication frame from the STA 112. Next, the AP 111 detects the signal strength of the communication frame from the STA 122 during transmission of only the communication frame transmitted from the STA 122. That is, the AP 111 detects the signal strength of the communication frame transmitted by the STA 122 at the AP 111.

In step S505, when the signal of the communication frame transmitted by the STA 122 stops, the AP 111 determines that the transmission of the communication frame transmitted by the STA 122 has ended.

In step S506, when the communication frame transmitted by the STA 122 is successfully received by the AP 121, which is the destination of this communication frame, the AP 121 returns Ack to the STA 122. The AP 111 monitors the Ack and detects the MAC address of the STA 122.

In step S507, the AP 111 transmits the signal strength of the communication frame from the STA 112 at the AP 111, the signal strength of the communication frame from the STA 122, and the MAC address of the STA 122, which are the information obtained by the series of processes performed up to this point, to the STA 112 as an SR Fail Report.

By performing the process of this flowchart, the AP can notify the STA, which has transmitted the communication frame to the AP, of a communication frame error. In this process, the AP can also notify the STA of information that the STA can refer to when the STA transmits data again.

A flowchart 510 in FIG. 5 illustrates a process that is performed when the STA 112 receives the SR Fail Report from the AP 111. The process in this flowchart is performed by, for example, the control unit 202 of the STA 112 executing a program stored in the storage unit 201.

In step S511, the STA 112 receives the SR Fail Report transmitted from the AP 111 in step S507.

In step S512, the STA 112 determines whether to retransmit the communication frame that has resulted in an error, based on the information included in the SR Fail Report received in step S511, for example, the signal strength of the signal transmitted by the STA 112 at the AP 111, the signal strength of the signal transmitted by the STA 122, the address of the STA 122, and the like. In a case where the STA 112 determines that the communication frame is not to be retransmitted (NO in step S512), the STA 112 ends the process.

In a case where the STA 112 determines that the communication frame is to be retransmitted in step S512 (YES in step S512), the processing proceeds to step S513. In step S513, the STA 112 retransmits the communication frame after performing one or more adjustments, such as changing the MCS of the communication frame and retransmitting the adjusted communication frame, changing the signal strength and retransmitting the adjusted communication frame, retransmitting the communication frame indicating that SR is prohibited, and the like. That is, the STA 112 performs any one or more of the following adjustments, which have been described above, and transmits the adjusted communication frame:
1. Change (lower) the degree of modulation (Modulation and Coding Scheme (MCS)) of the communication frame in such a manner that the demodulation can be performed by the AP 111 even when the SINR is low.
2. Increase the signal strength per frequency in such a manner that the SINR is increased, and
3. Determine that SR is not to be used, and change the PHY header portion to prohibit SR,
that is, stop transmitting the communication frame indicating that SR is allowed, and transmit the communication frame indicating that SR is prohibited.
For example, the STA 112 changes the parameters of the corresponding fields of the frame illustrated in FIG. 6, and transmits the adjusted communication frame.

By performing the process in the individual flowchart above, even when the communication frame transmitted by the STA is not properly received by the AP, the STA can retransmit the communication frame configured with the optimal parameters that prevent a reception error.

### OTHER EMBODIMENTS

Although the above embodiments have been described in connection with a wireless LAN communication compliant with the IEEE 802.11 series, the present disclosure is not limited thereto. For example, the present disclosure may be applied to a specific frame using a wireless communication medium, such as wireless USB, Multi Band OFDM Alliance (MBOA), Bluetooth®, UWB, ZigBee, or NFC. Examples of the UWB technologies include Wireless USB, Wireless IEEE 1394, and WINET.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The disclosure of the embodiments includes the following configuration, method, and program.

### (Configuration 1)

A communication apparatus that executes communication compliant with IEEE 802.11, the communication apparatus comprising:
a first receiving unit configured to receive at least part of a first communication frame including information indicating that Special Reuse (SR) is allowed, the first communication frame having been transmitted by a first different communication apparatus;
a detecting unit configured to detect a second communication frame that interferes with reception of the first communication frame, the second communication frame having been transmitted by a second different communication apparatus; and
a notifying unit configured to notify the first different communication apparatus of an error in reception of the first communication frame, based on a signal strength of the signal received by the first receiving unit and a signal strength of the second communication frame detected by the detecting unit.

### (Configuration 2)

The communication apparatus according to Configuration 1, further including:
an acquiring unit configured to acquire identification information about the second different communication apparatus,
wherein the notifying unit further notifies the first different communication apparatus of the identification information.

### (Configuration 3)

The communication apparatus according to Configuration 2, wherein the acquiring unit acquires the identification information about the second different communication apparatus by receiving an Acknowledgement (Ack) transmitted by a third different communication apparatus in response to the second communication frame.

### (Configuration 4)

The communication apparatus according to Configuration 2 or 3, wherein the identification information is a Media Access Control (MAC) address.

### (Configuration 5)

The communication apparatus according to any one of Configurations 1 to 4, wherein the notifying unit performs a notification of the error in a case where a frame error rate is equal to or greater than a predetermined ratio, and does not perform the notification of the error in a case where the frame error rate is not equal to or greater than the predetermined ratio.

### (Configuration 6)

The communication apparatus according to any one of Configurations 1 to 5, wherein the notifying unit notifies the first different communication apparatus of the signal strength of the signal received by the first receiving unit and the signal strength of the second communication frame detected by the detecting unit.

### (Configuration 7)

The communication apparatus according to any one of Configurations 1 to 6, wherein the first different communication apparatus retransmits a communication frame, based on the signal strength of the signal received by the first receiving unit and the signal strength of the second communication frame detected by the detecting unit, which have been notified by the notifying unit.

### (Configuration 8)

The communication apparatus according to any one of Configurations 1 to 7, wherein the first different communication apparatus changes a Modulation and Coding Scheme (MCS) and retransmits a communication frame, based on the signal strength of the signal received by the first receiving unit and the signal strength of the second communication frame detected by the detecting unit, which have been notified by the notifying unit.

### (Configuration 9)

The communication apparatus according to any one of Configurations 1 to 8, wherein the first different communication apparatus changes a signal strength and retransmits a communication frame, based on the signal strength of the signal received by the first receiving unit and the signal strength of the second communication frame detected by the detecting unit, which have been notified by the notifying unit.

### (Configuration 10)

The communication apparatus according to any one of Configurations 1 to 9, wherein the first different communication apparatus retransmits a communication frame indicating prohibition of Special Reuse (SR), based on the signal strength of the signal received by the first receiving unit and the signal strength of the second communication frame detected by the detecting unit, which have been notified by the notifying unit.

### (Method 1)

A control method executed by a communication apparatus that executes communication compliant with IEEE 802.11, the control method including:
receiving, as first receiving, at least part of a first communication frame including information indicating that Special Reuse (SR) is allowed, the first communication frame having been transmitted by a first different communication apparatus;
detecting a second communication frame that interferes with reception of the communication frame, the second communication frame having been transmitted by a second different communication apparatus; and
notifying the first different communication apparatus of an error in reception of the first communication frame, based on a signal strength of the signal received by the first receiving and a signal strength of the second communication frame detected by the detecting.

### (Program 1)

A program causing a computer to function as a communication apparatus according to any one of configurations 1 to 10.

The disclosure is not limited to the above-described embodiments, and various variations and modifications are possible without departing from the spirit and scope of the disclosure. Thus, claims will be attached to the disclosure, in order to make the scope of the disclosure public.

The present disclosure enables execution of suitable communication even when an error has occurred during execution of SR processing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus that executes communication compliant with IEEE 802.11, the communication apparatus comprising:
at least one memory that stores a set of instructions; and
at least one processor that executes the instructions, the instructions, when executed, causing the communication apparatus to perform operations comprising:
receiving, as first receiving, at least part of a first communication frame including information indicating that Special Reuse (SR) is allowed, the first communication frame having been transmitted by a first different communication apparatus;
detecting a second communication frame that interferes with reception of the first communication frame, the second communication frame having been transmitted by a second different communication apparatus; and
notifying the first different communication apparatus of an error in reception of the first communication frame, based on a signal strength of the signal received by the first receiving and a signal strength of the second communication frame detected by the detecting.

2. The communication apparatus according to claim 1, wherein the operations further comprising:
acquiring identification information about the second different communication apparatus,
wherein in the notifying, the communication apparatus further notifies the first different communication apparatus of the identification information.

3. The communication apparatus according to claim 2, wherein in the acquiring, the communication apparatus acquires the identification information about the second different communication apparatus by receiving an Acknowledgement (Ack) transmitted by a third different communication apparatus in response to the second communication frame.

4. The communication apparatus according to claim 2, wherein the identification information is a Media Access Control (MAC) address.

5. The communication apparatus according to claim 1, wherein in the notifying, the communication apparatus performs a notification of the error in a case where a frame error rate is equal to or greater than a predetermined ratio, and does not perform the notification of the error in a case where the frame error rate is not equal to or greater than the predetermined ratio.

6. The communication apparatus according to claim 1, wherein in the notifying, the communication apparatus notifies the first different communication apparatus of a signal strength of a signal received by the first receiving and a signal strength of the second communication frame detected by the detecting.

7. The communication apparatus according to claim 6,
wherein in the notifying, a notification of the signal strength of the signal received by the first receiving and the signal strength of the second communication frame detected by the detecting is performed, and
wherein the first different communication apparatus retransmits a communication frame, based on the signal strength of the signal received by the first receiving and the signal strength of the second communication frame detected by the detecting.

8. The communication apparatus according to claim 6,
wherein in the notifying, a notification of the signal strength of the signal received by the first receiving and the signal strength of the second communication frame detected by the detecting is performed, and
wherein the first different communication apparatus changes a Modulation and Coding Scheme (MCS) and retransmits a communication frame, based on the signal strength of the signal received by the first receiving and the signal strength of the second communication frame detected by the detecting.

9. The communication apparatus according to claim 6,
wherein in the notifying, a notification of the signal strength of the signal received by the first receiving and the signal strength of the second communication frame detected by the detecting is performed, and
wherein the first different communication apparatus changes a signal strength and retransmits a communication frame, based on the signal strength of the signal received by the first receiving and the signal strength of the second communication frame detected by the detecting.

10. The communication apparatus according to claim 6,
wherein in the notifying, a notification of the signal strength of the signal received by the first receiving and the signal strength of the second communication frame detected by the detecting is performed, and
wherein the first different communication apparatus retransmits a communication frame indicating prohibition of Special Reuse (SR), based on the signal strength of the signal received by the first receiving and the signal strength of the second communication frame detected by the detecting.

11. A control method executed by a communication apparatus that executes communication compliant with IEEE 802.11, the control method comprising:
receiving, as first receiving, at least part of a first communication frame including information indicating that Special Reuse (SR) is allowed, the first communication frame having been transmitted by a first different communication apparatus;
detecting a second communication frame that interferes with reception of the first communication frame, the second communication frame having been transmitted by a second different communication apparatus; and
notifying the first different communication apparatus of an error in reception of the first communication frame, based on a signal strength of the signal received by the first receiving and a signal strength of the second communication frame detected by the detecting.

12. A non-transitory computer-readable storage medium that stores a program that causes, when the program is executed, a communication apparatus to perform:
receiving, as first receiving, at least part of a first communication frame that includes information indicating that Special Reuse (SR) is allowed, the first communication frame having been transmitted by a first different communication apparatus;
detecting a second communication frame that interferes with reception of the first communication frame, the second communication frame having been transmitted by a second different communication apparatus; and
notifying the first different communication apparatus of an error in reception of the first communication frame, based on a signal strength of the signal received by the first receiving and a signal strength of the second communication frame detected by the detecting.
